(19) United States
(12) Patent Application Publication
(10) Pub. No.: US 2007/0147955 A1
(43) Pub. Date: Jun. 28, 2007

(54) Quick gear changing engine hub assembly

(76) Inventor: Bill Moore, Virden, IL (US)

Correspondence Address: ROBERT M. PATINO, 1901 S. PASFIELD, SPRINGFIELD, IL, 62704, US

(21) Appl. No.: 11/319,244

(22) Filed: Dec. 28, 2005

(51) Int. Cl. B25G 3/00

(52) U.S. Cl. 403/233

(57) ABSTRACT

An engine hub assembly for use on a motor containing an engine shaft member for turning a motor gear is provided that includes an engine hub fixable to the engine shaft member, a female securement nut associated with the engine hub such that the female securement nut is fastenable to the engine hub, and a means of coupling the motor gear to the engine hub.

### BACKGROUND OF THE INVENTION

The present invention relates to an engine hub assembly for a motor, and more particularly to such an engine hub assembly used in small-sized racing vehicles that allows for quick disassembly and assembly for replacing motor gears.

Quarter Midget racing is becoming an increasingly popular sport among children between the ages of 5 and 16. The entire family often gets involved and the sport allows the family to participate in one form or the other. Quarter Midget race cars that are used in the races involve cars that are approximately ¼ the size of Midget race cars. Quarter Midget race cars employ a 120 to 150 cc single cylinder engine, and also use independent suspensions and incorporate rolling cages. These Quarter Midget race cars allow children to learn basic mechanical concepts related to internal combustion engine powered vehicles, along with providing them with invaluable safety concepts and instilling a healthy competitive spirit. Furthermore, good coordination, timing and other physical skills are developed that make the children more adept in other activities.

Quarter Midget race cars generally operate on 1/20 mile oval tracks that are composed of various surfaces such as concrete, dirt or asphalt. However, after sufficient usage, the mechanical parts of the vehicle become worn and need to be replaced. The engine hub is a particular piece that needs to be changed quickly either during a race or in between races. The engine hub supports a motor gear that drives a chain, which in turn drives a rear axle gear connected to the rear axle. It is the rear axle that maintains the rear set of wheels and propels the car.

Current engine hubs require the motor gear to be bolted to the engine hub. In order to change the motor gear, the entire engine hub assembly has to be pulled off an engine shaft member of the motor. This task proves difficult in most Quarter Midget race cars because there are immoveable bars and other parts that obstruct the removal of the engine hub. Furthermore, once the engine hub and motor gear are removed, bolts that keep the motor gear in place need to be removed in order to add a new motor gear which adds additional time. Once the new motor gear is in place, the new motor gear needs to be secured by the bolts to the engine hub. The new engine hub and new motor gear are then placed back on the engine shaft member which often results in an altered chain alignment due to uneven tightening of the bolts or other human error.

Another issue not addressed by current engine hub designs is reassembly of the engine hub with the motor gear by children or adults fastening the bolts improperly. If the bolts are not properly fastened, the bolts will become loose and an alignment key could fall out. An engine hub assembly acting without the alignment key would cause serious damage to the engine shaft member and potentially injure the driver while in operation.

Therefore, it is desired to have engine hub assembly that allows for quick disassembly and assembly for replacing motor gears. Furthermore, it is desired that this engine hub assembly be simple mechanically and easily installable such that adults and children of reasonable competence can use the engine hub assembly. The process of removing and installing the motor gear is desired to be made easier with the obstruction of safety bars and other immoveable parts. Additionally, the engine hub assembly must be secure enough such that the motor gear does not become loose or misaligned.

Thus, there is a need for an engine hub assembly capable of providing quick access to the motor gear. Moreover, there is a need for such an engine hub assembly to be fixable to the engine shaft member such that misalignment of the motor gear does not occur, further limiting any potential of the alignment key falling out.

### BRIEF SUMMARY OF THE INVENTION

The above-identified needs are addressed by the present engine hub assembly for use on a motor containing an engine shaft member. One feature of the present invention is an engine hub assembly that is provided with a means of changing a motor gear without needing to remove an engine hub. With the engine hub fixedly secured to the engine shaft member, new motor gears placed on the engine hub will be ensured the same alignment as the previous motor gear. By providing a means of coupling the motor gear to the engine hub, simultaneous rotation between the engine hub and the motor gear can be ensured. When a rotational action is created by the engine shaft member, the motor gear will be forced to rotate with the engine hub. An additional feature of the engine hub assembly is a means of fastening a female securement nut to the engine hub. In the preferred embodiment, the female securement nut is rotated or screwed onto a male tethering portion of the engine hub which allows for quick removal and replacement of the motor gear.

More specifically, an engine hub assembly for use on a motor containing an engine shaft member for turning a motor gear is provided that includes an engine hub. The engine hub is fixable to the engine shaft member and is provided with a male tethering portion. A female securement nut is associated with the engine hub such that the female securement nut is fastenable to the male tethering portion. A means of coupling the motor gear to the engine hub provides simultaneous rotation between the engine hub and the motor gear when a rotational action transpires on the engine shaft member.

In another embodiment, an engine hub assembly for use on a motor containing an engine shaft member for turning a motor gear is provided with an engine hub fixable to the engine shaft member. At least one gear positioning spoke is also included that extends perpendicularly from a gear facing surface of the engine hub, wherein the at least one gear positioning spoke is extended to a distance to provide coupling with the motor gear. A means of fastening a female securement nut to the engine hub is further provided to ensure that the female securement nut does not become loose or dislodged.

In yet another embodiment, an engine hub assembly for use on a motor containing an engine shaft member for turning a motor gear is provided with an engine hub fixable to the engine shaft member. The engine hub in this embodiment is provided with a male tethering portion. A female securement nut is associated with the engine hub such that the female securement nut is fastenable to the male tethering portion. And at least one gear positioning spoke is further included that extends perpendicularly from a gear facing surface of the engine hub and is extended to a distance to provide coupling with the motor gear.

### BRIEF DESCRIPTION OF THE DRAWINGS

FIG. 1 is a blown-up perspective view of a Quarter Midget race car revealing an engine hub assembly shown in its assembled position.

FIG. 2 is a close up frontal view the engine hub assembly facing a motor as it resides in its assembled position.

FIG. 3 is a separated side perspective of the engine hub assembly as it resides in its disassembled position.

FIG. 4 is a section view from a perspective of an engine hub showing a fastening pin in a fastening pin channel.

FIG. 5 is a cut-out side view of the engine hub assembly as it resides in its assembled position.

### DETAILED DESCRIPTION OF THE INVENTION

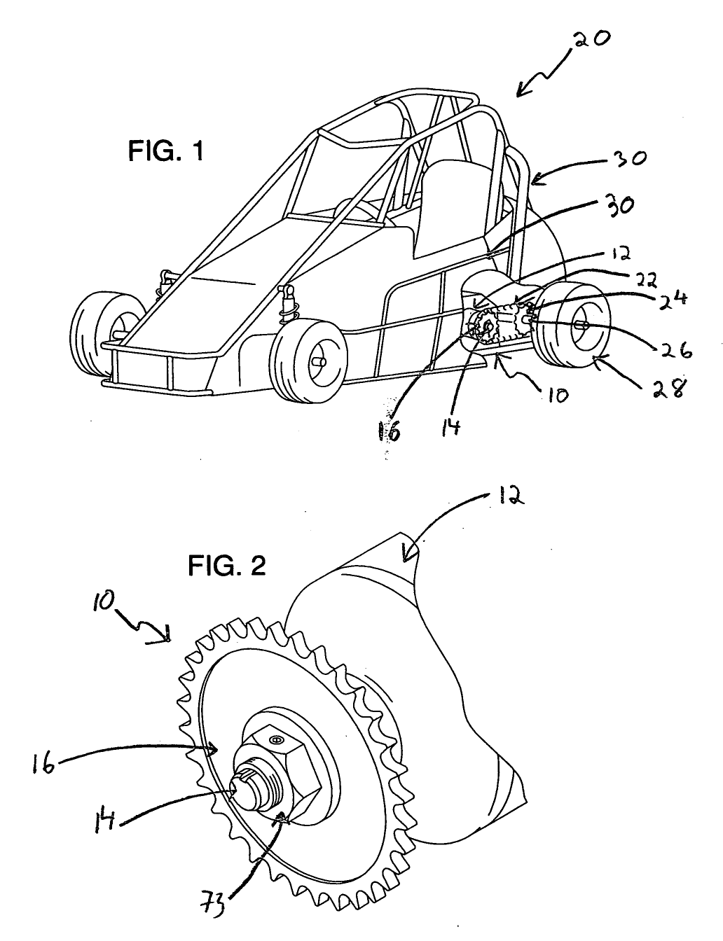

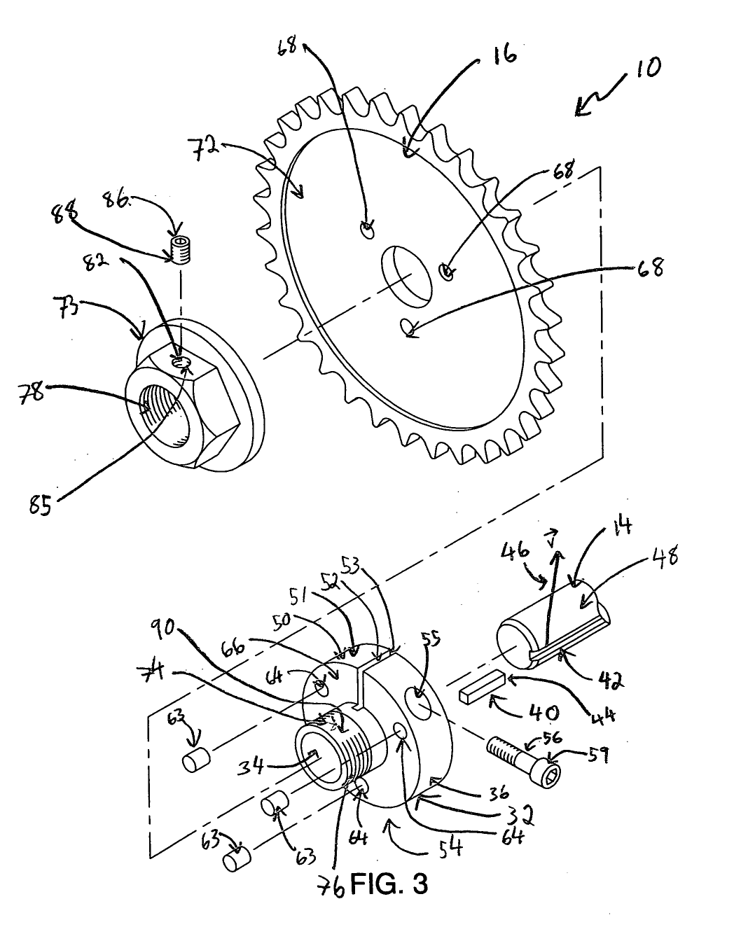

Referring now to FIGS. 1 and 2, an engine hub assembly for use on a motor is generally designated 10. Driving the engine hub assembly 10 is a motor 12 that includes an engine shaft member 14 for turning a motor gear 16. The motor 12 is preferably of an internal combustion engine design; however, it is appreciated that electrical and other drive mechanisms that are capable of rotating an engine shaft member 14 may also be used.

Now referring to FIG. 1, the motor 12 is preferably housed in a vehicle generally designated 20. In the most preferred embodiment, the vehicle 20 is of a Quarter Midget race car design. In these vehicles, the motor 12 used to drive the engine shaft member 14 is a single cylinder internal combustion engine. As the engine shaft member 14 rotates, the engine hub assembly 10 rotates simultaneously. The motor gear 16 coupled to the engine hub assembly 10 in turn moves a drive chain 22 that rotates an axle gear 24 connected to a rear axle 26. The rear axle 26 manipulates a set of rear wheels 28 that propel the vehicle 20.

For safety reasons, protection bars 30 are incorporated throughout the vehicle 20. The protections bars 30, along with paneling, make it difficult to gain access to the engine hub assembly 10. Protection bars 30 operate to protect a driver of the vehicle 20 and the motor 12 along with its associated moving parts. Alignment issues between the motor gear 16 and the axle gear 24 are reduced with the present engine hub assembly 10 when the motor gear 16 needs to be replaced as described in further detail below.

Now referring to FIGS. 2 and 3, an engine hub 32 fixable to the engine shaft member 14 is provided to ensure consistent accurate alignment for the motor gear 16. In the preferred embodiment, the engine hub 32 is of a “C-clamp” design to make the engine hub 32 removable from the engine shaft member 14. The “C-clamp” design allows the engine hub 32 to more securely attach itself to the engine shaft member 14 which are typically made of a round, solid metal rod protruding from the motor 12. However, it is appreciated that other types of engine shaft members 14 might be employed that would alter the “C-clamp” preferred embodiment design. By keeping the engine hub 32 affixed to the engine shaft member 14, a new motor gear is mounted in the same alignment as the previous motor gear when the motor gear 16 is replaced.

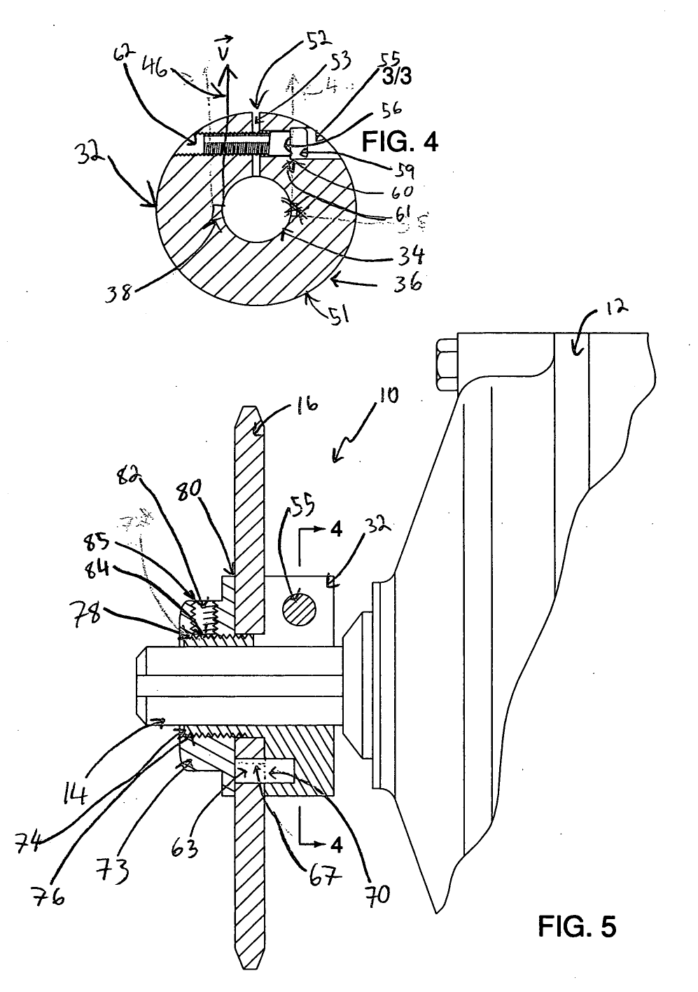

Now referring to FIGS. 3 and 4, the engine hub 32 further comprises an inner surface 34 and an outer surface 36. The inner surface 34 is provided to receive the engine shaft member 14. In the preferred embodiment, engine hub 32 comprises a hub key slot 38 on the inner surface 34. The hub key slot 38 is a bored out region provided to receive an alignment key 40. The engine shaft member 14 is provided with an opposing key slot 42, so that when the alignment key 40 is placed into the opposing key slot 42, the hub key slot 38 conforms to a protruding end 44 of the alignment key 40 when the engine hub 32 is placed on the engine shaft member 14. The alignment key 40, hub key slot 38 and opposing key slot 42 offer a consistent placement point for the engine hub 32 each time the engine hub 32 is reinstalled. The alignment key 40 further provides a vector force 46 tangent to a shaft circumference 48 of the engine shaft member 14 to propel the engine hub 32 rotatably. The outer surface 36 forms a hub circumferential plane 50 located at an outside end 51 away from the engine shaft member 14.

In the preferred embodiment, the engine hub 32 is fixable to the engine shaft member 14 by reducing the width of a loosening slot 52. The loosening slot 52 extends from the outer surface 36 to the inner surface 34 to form a gap 53 in the “C” shaped body of the C-clamp. The loosening slot 52 is of sufficient width such that when the engine hub 32 resides in a loosened position 54 (as shown in FIG. 3), the engine hub 32 is moveable along the engine shaft member 14 with little or no resistance. Reducing the width of the loosening slot 52 collapses the diameter of the inner surface 34, resulting in a closing action that causes the engine hub 32 to grip and fix to the engine shaft member 14.

Now referring to FIG. 4, a means of closing the loosening slot 52 is preferably provided by a fastening pin channel 55 and a fastening pin 56. The fastening pin channel 55 extends from an insertion side 57 of the outer surface 36, through the loosening slot 52, and ends at an exiting side 58 of the outer surface 36. The fastening pin 56 is preferably tethered and is provided with a pin head 59. The pin head 59 prevents the fastening pin 56 from sliding through the fastening pin channel 55 at a catch point 60. The catch point 60 is provided with shoulders 61 inside the fastening in channel 55 to provide a pulling means for the fastening pin 56. A binding region 62 of the fastening pin channel 55 is located between the loosening slot 52 and the exiting side 58 and is provided with riveted walls. The fastening pin 56 is fed through the fastening pin channel 55 up to the catch point 60 and rotated into the binding region 62 for closing the loosening slot 52. The closing action secures the engine hub 32 to the engine shaft member 14. The loosening slot 52 may be reopened by a reverse rotation action of the fastening pin 56 to allow the engine hub 32 to be removable.

Now referring to FIGS. 2, 3, and 5, the engine hub assembly 10 provides a means of coupling the motor gear 16 to the engine hub 32. In the preferred embodiment, the means of coupling provides simultaneous rotation and prevents slippage between the engine hub 32 and the motor gear 16 when the engine shaft member 14 rotates. Preferably, the means of coupling the motor gear 16 to the engine hub 32 is provided by an at least one gear positioning spoke 63.

In the most preferred embodiment, three gear positioning spokes 63 are provided; however, it is appreciated that this number may vary to provide a similar coupling means. The at least one gear positioning spoke 63 is shaped similar to a small cylindrical rod and is of similar width to a respective hub spoke hole spoke hole 64 of a gear facing surface 66 of the engine hub 32. The at least one gear positioning spoke 63 is placed fixedly into the respective hub spoke hole 64 by boring the at least one gear positioning spoke 63 to an unmoving position within the respective hub spoke hole 64 on the gear facing surface 66 of the engine hub 32.

Now referring to FIG. 5, the at least one gear positioning spoke 63 protrudes to a distance 67 perpendicularly from the gear facing surface 66 of the engine hub 32 to provide sufficient coupling in a motor gear spoke hole 68 of the motor gear 16. It is preferred that the distance 67 is approximately equal to a width distance 70 of the motor gear 16 such that the distance 67 sits flush with a nut facing surface 72 of the motor gear 16. Furthermore, it is preferred that the at least one gear positioning spoke 63 is of sufficient width to tightly conform to the perimeter or circumference of the motor gear spoke hole 68. The at least one gear positioning spoke 63 is preferably made of a durable, resilient material to withstand the stress forces associated with rotation of the motor gear 16 and vibrations caused by the motor 12 and track.

Now referring to FIGS. 3 and 5, the engine hub assembly 10 is further provided with a female securement nut 73 that is associated with a nose end 74 of the engine hub 32. The nose end 64 of the engine hub 32 extends outwardly from the gear facing surface 66 and closely conforms to the engine shaft member 14. The female securement nut 73 is provided with a means of fastening to the engine hub 32. In the preferred embodiment, the nose end 74 of the engine hub 32 is laced with a male tethering portion 76. Preferably, the female securement nut 73 is associated with the engine hub 32 such that the female securement nut 73 is fastenable to the male tethering portion 76. The female securement nut 73 is provided with a female coupling portion 78 designed to accommodate and receive the male tethering portion 76 of the engine hub 32.

Now referring to FIG. 5, in the most preferred embodiment, the female securement nut 73 completes the engine hub assembly 10 by rotating onto the male tethering portion 76 of the nose end 74 to a tightened point 80 where the motor gear 16 and/or the at least one gear positioning spoke 63 sits flush against the female securement nut 73. At the tightened point 80, the female securement nut 73 clenches the motor gear 16 to the engine hub 32 on the engine shaft member 14. The motor gear 16 becomes fixed and secured onto the engine hub 32 when the female securement nut 73 resides at the tightened point 80. The motor gear 15 is removable when the female securement nut 73 is rotated in an opposite manner from its tightening rotation until the female securement nut 73 is no longer engaged with the engine hub 32.

Now referring to FIGS. 3 and 5, the female securement nut 73 is preferably provided with a means of staying fastened to the engine hub 32. In the preferred embodiment, a screw receiving hole 82 provides a means of fastening the female securement nut 73 to the nose end 74 of the engine hub 32. The screw receiving hole 82 is arranged such that a bottom end 84 of the screw receiving hole 82 is exposable to the male tethering portion 76 of the engine hub 32. A top end 85 of the screw receiving hole 82 is exposed externally to receive an immobilizing screw 86. The immobilizing screw 86 is inserted into the screw receiving hole 82 wherein a bottom tip 88 of the immobilizing screw 86 immobilizes the female securement nut 73 to the engine hub 32 by creating a friction force at a contact point 90. The immobilizing screw 86 is preferably provided with Teflon covering at the bottom tip 88 to allow for elastic gripping of the immobilizing screw 86 to the engine hub 32.

While a particular embodiment of the present engine hub assembly has been described herein, it will be appreciated by those skilled in the art that changes and modifications may be made thereto without departing from the invention in its broader aspects and as set forth in the following claims.

1) An engine hub assembly for use on a motor containing an engine shaft member for turning a motor gear, the engine hub assembly comprising:
an engine hub fixable to the engine shaft member, said engine hub is provided with a male tethering portion;
a female securement nut associated with said engine hub such that said female securement nut is fastenable to said male tethering portion; and
a means of coupling the motor gear to said engine hub, wherein said means of coupling provides simultaneous rotation between said engine hub and the motor gear when a rotational action is created by the engine shaft member.

2) The engine hub assembly of claim 1, wherein said engine hub further comprises an inner surface for receiving the engine shaft member and an outer surface.

3) The engine hub assembly of claim 2, wherein said engine hub further comprises a hub key slot on said inner surface.

4) The engine hub assembly of claim 2, wherein said engine hub further comprises a loosening slot that extends from said outer surface to said inner surface.

5) The engine hub assembly of claim 4, wherein said engine hub further comprises a fastening pin channel that extends from an insertion side of said outer surface, through said loosening slot, and ends at an exiting side of said outer surface.

6) The engine hub assembly of claim 5, wherein said engine hub further comprises a fastening pin through said fastening pin channel for closing said loosening slot.

7) The engine hub assembly of claim 1, wherein said female securement nut further comprises a screw receiving hole arranged such that a bottom end of said screw receiving hole is exposable to said male tethering portion of said engine hub.

8) The engine hub assembly of claim 7, wherein an immobilizing screw is inserted into said screw receiving hole wherein a bottom tip of said screw immobilizes said female securement nut with respect to said engine hub at said bottom end of said screw receiving hole.

9) The engine hub assembly of claim 1, wherein said means of coupling the motor gear to said engine hub is provided by an at least one gear positioning spoke.

10) The engine hub assembly of claim 9, wherein said at least one gear positioning spoke extends perpendicularly from a gear facing surface of said engine hub to a distance approximately equal to a width distance of the motor gear.

11) An engine hub assembly for use on a motor containing an engine shaft member for turning a motor gear, the engine hub assembly comprising:
an engine hub fixable to the engine shaft member;
a female securement nut associated with said engine hub such that said female securement nut is fastenable to said engine hub;
at least one gear positioning spoke extends perpendicularly from a gear facing surface of said engine hub, said at least one gear positioning spoke is extended to a distance to provide coupling with the motor gear; and
said female securement nut is provided with a means of fastening to said engine hub.

12) The engine hub assembly of claim 11, wherein said engine hub is fixable to the engine shaft member said engine hub by tightening a loosening slot that extends from an outer surface of said engine hub to an inner surface for receiving the engine shaft member.

13) The engine hub assembly of claim 11, wherein said means of fastening to said engine hub is a male tethering portion.

14) The engine hub assembly of claim 13, wherein said female securement nut is rotated onto said male tethering portion until said female securement nut clenches the motor gear to said engine hub on the engine shaft member.

15) The engine hub assembly of claim 14, wherein a screw is inserted into a screw receiving hole wherein a bottom tip of said immobilizing screw immobilizes said female securement nut with respect to said engine hub at a bottom end of said screw receiving hole.

16) The engine hub assembly of claim 11, wherein said at least one gear positioning spoke extends to a flush position with a width distance of the motor gear.

17) The engine hub assembly of claim 11, wherein said at least one gear positioning spoke is placed fixedly into a respective hub spoke hole of a gear facing surface of the engine hub.

18) An engine hub assembly for use on a motor containing an engine shaft member for turning a motor gear, the engine hub assembly comprising:
an engine hub fixable to the engine shaft member, said engine hub is provided with a male tethering portion;
a female securement nut associated with said engine hub such that said female securement nut is fastenable to said male tethering portion; and
at least one gear positioning spoke extends perpendicularly from a gear facing surface of said engine hub, said at least one gear positioning spoke is extended to a distance to provide coupling with the motor gear.
